(19) United States
(12) Patent Application Publication
(10) Pub. No.: US 2025/0058439 A1
(43) Pub. Date: Feb. 20, 2025

(54) SWING WRENCH

(71) Applicant: KABO TOOL COMPANY, Taichung City (TW)

(72) Inventor: Chih-Ching HSIEH, Taichung City (TW)

(21) Appl. No.: 18/801,662

(22) Filed: Aug. 12, 2024

Related U.S. Application Data
(60) Provisional application No. 63/532,888, filed on Aug. 15, 2023.

(51) Int. Cl. B25B 23/00; B25B 13/46

(52) U.S. Cl. CPC B25B 23/0028; B25B 13/46

(57) ABSTRACT

A swing wrench includes a driving head, a handle, a pressing element and a positioning element. The driving head has a first protruding ear structure, wherein an inner surface of the first protruding ear structure has a smooth portion and a toothed portion. The handle has two second protruding ear structures, wherein the first protruding ear structure is disposed between the second protruding ear structures. The positioning element is engaged with the pressing element, and the pressing element and the positioning element are disposed through the first protruding ear structure and the second protruding ear structures.

### RELATED APPLICATIONS

This application claims priority to U.S. Provisional Application Ser. No. 63/532,888 filed Aug. 15, 2023, which is herein incorporated by reference.

### BACKGROUND

### Technical Field

The present disclosure relates to a swing wrench. More particularly, the present disclosure relates to a swing wrench which can flexibly adjust the swing angle.

### Description of Related Art

The swing wrench is a widely used hand tool, and the users can adjust the angle between the driving head and the handle of the swing wrench for corresponding to the angle of the target object, so that the problem of hardly forcing caused by the spatial limitation can be avoided. However, the swing wrench of the prior art has some difficult problems before the operation and during the operation process, such as the problem of hardly fixing the angle between the driving head and the handle owing to the force during the operation process, and the problem of the difficulty in adjusting the angle between the driving head and the handle before using the swing wrench.

Therefore, a swing wrench, which can easily adjust the swing angle and stabilize the swing angle during the operation process, needs to be developed.

### SUMMARY

According to one aspect of the present disclosure, a swing wrench includes a driving head, a handle, a pressing element and a positioning element. The driving head has a first protruding ear structure, wherein an inner surface of the first protruding ear structure has a smooth portion and a toothed portion. The handle has two second protruding ear structures, wherein the first protruding ear structure is disposed between the second protruding ear structures. The positioning element is engaged with the pressing element, and the pressing element and the positioning element are disposed through the first protruding ear structure and the second protruding ear structures. When a length of the toothed portion is L1, and a total length of the smooth portion and the toothed portion is L2, the following condition is satisfied:

$$L 1 < \frac{1}{2} L 2.$$

### BRIEF DESCRIPTION OF THE DRAWINGS

FIG. 1 is a three-dimensional view of a swing wrench according to an example of the present disclosure.

FIG. 2 is an exploded view of the swing wrench according to the example in FIG. 1.

FIG. 3 is another exploded view of the swing wrench according to the example in FIG. 1.

FIG. 4 is a cross-sectional view of the swing wrench according to the example in FIG. 1.

FIG. 5 is a partial cross-sectional view of the swing wrench according to the example in FIG. 1.

FIG. 6 is an exploded view of a swing wrench according to another example of the present disclosure.

FIG. 7 is a cross-sectional view of the swing wrench according to the example in FIG. 6.

### DETAILED DESCRIPTION

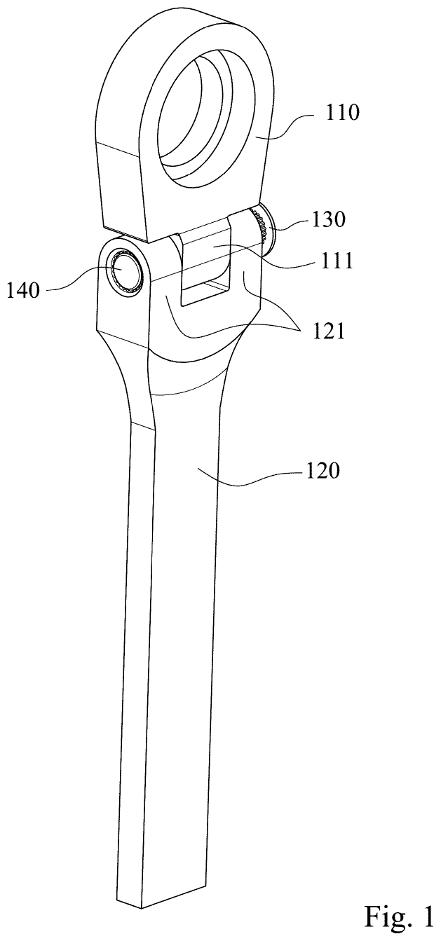

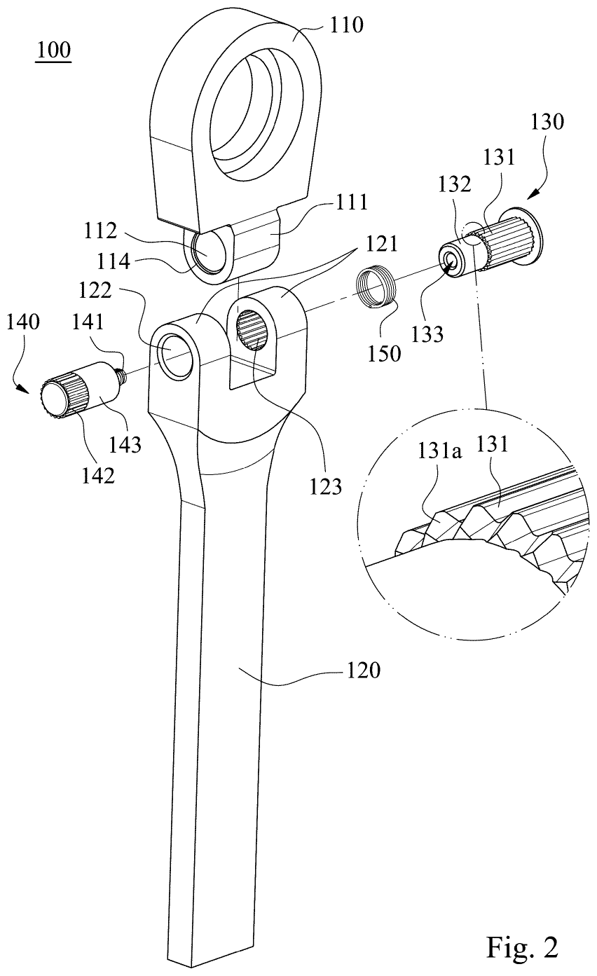

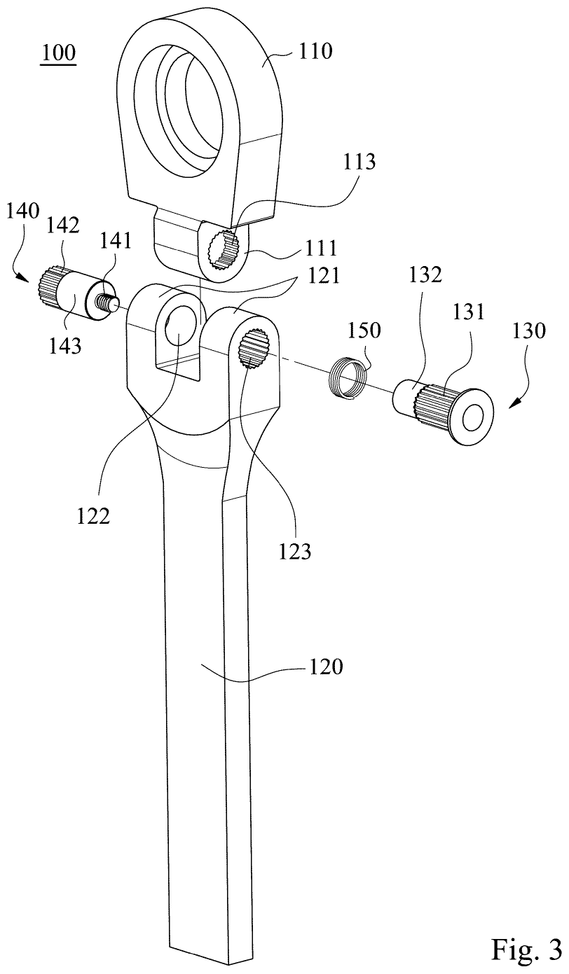

FIG. 1 is a three-dimensional view of a swing wrench 100 according to an example of the present disclosure. FIG. 2 is an exploded view of the swing wrench 100 according to the example in FIG. 1. FIG. 3 is another exploded view of the swing wrench 100 according to the example in FIG. 1. In FIGS. 1 to 3, the swing wrench 100 includes a driving head 110, a handle 120, a positioning element 130 and a pressing element 140, wherein the driving head 110 has a first protruding ear structure 111, the handle 120 has two second protruding ear structures 121, the first protruding ear structure 111 is disposed between the second protruding ear structures 121, the positioning element 130 is engaged with the pressing element 140, and the pressing element 140 and the positioning element 130 are disposed through the first protruding ear structure 111 and the second protruding ear structures 121.

In particular, the angle between the driving head 110 and the handle 120 can be adjusted during pressing the pressing element 140, and the engagement between the positioning element 130 and the pressing element 140 can be configured to fix the determined swing angle between the driving head 110 and the handle 120.

In FIGS. 2 and 3, an inner surface of the first protruding ear structure 111 has a smooth portion 112 and a toothed portion 113, and the second protruding ear structures 121 can have a smooth inner surface 122 and a toothed inner surface 123, respectively, wherein the smooth inner surface 122 is corresponding to the smooth portion 112, and the toothed inner surface 123 is corresponding to the toothed portion 113.

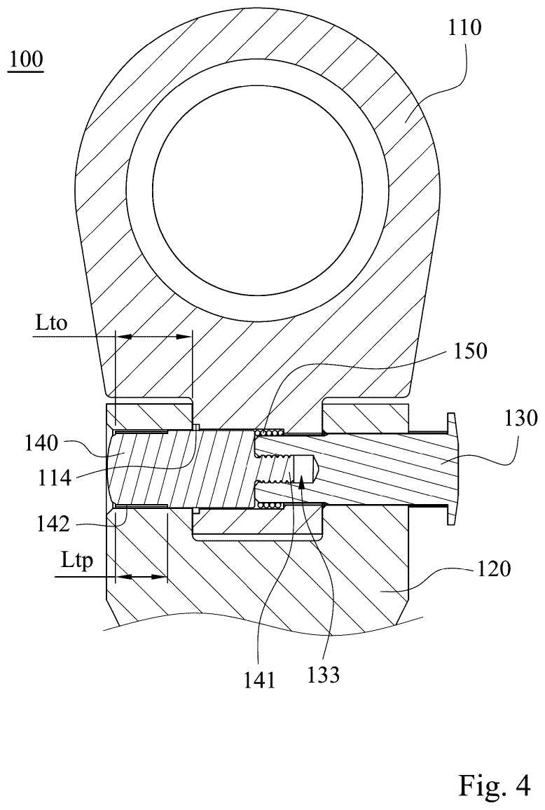

FIG. 4 is a cross-sectional view of the swing wrench 100 according to the example in FIG. 1, wherein FIG. 4 is the schematic view of the swing wrench 100 during pressing the pressing element 140 for the adjustment. In FIGS. 3 and 4, the positioning element 130 can have a toothed end 131 and a smooth end 132, wherein the toothed end 131 is engaged with the toothed inner surface 123 of the second protruding ear structure 121. Therefore, the toothed end 131 of the positioning element 130 can be engaged with the toothed inner surface 123 of the second protruding ear structure 121 during pressing the pressing element 140, so that the angle between the driving head 110 and the handle 120 is adjusted. Furthermore, the toothed end 131 of the positioning element 130 can be engaged with the toothed portion 113 of the first protruding ear structure 111 and the toothed inner surface 123 of the second protruding ear structure 121 without pressing the pressing element 140, so that the swing angle between the driving head 110 and the handle 120, which is after set, can be fixed.

In FIGS. 2 to 4, the pressing element 140 can have a first engaging end 141, and the positioning element 130 can have a second engaging end 133, wherein the first engaging end 141 and the second engaging end 133 are engaged with each other, the first engaging end 141 can be a protruding structure, and a surface of the protruding structure is threaded. That is, the first engaging end 141 and the second engaging end 133 are screw-locked. Therefore, the positioning element 130 can be tightly integrated with the pressing element 140.

The swing wrench 100 can further include an elastic element 150, wherein the elastic element 150 is disposed on the smooth end 132 of the positioning element 130, so that the reset after pressing the pressing element 140 can be achieved. Moreover, the elastic element 150 can be a spring, but the present disclosure is not limited thereto.

In FIGS. 2 and 4, the smooth portion 112 can have a threaded portion 114, wherein the threaded portion 114 is located on an end of the smooth portion 112, and the toothed portion 113 is located on the other end of the smooth portion 112. In particular, a connecting element (not shown) can be further disposed on the threaded portion 114 by disposing the threaded portion 114, so that the connecting strength between the pressing element 140 and the driving head 110 can be adjusted.

In FIG. 2, the toothed end 131 of the positioning element 130 has a corresponding toothed structure 131a, wherein the corresponding toothed structure 131a is disposed on an end of the toothed end 131, which is connected to the smooth end 132. Therefore, the engaging-alignment between the toothed portion 113 and the toothed inner surface 123 can be enhanced via the corresponding toothed structure 131a.

In FIG. 4, the pressing element 140 can have a toothed outer surface 142 and a smooth outer surface 143, wherein when a length of the toothed outer surface 142 is Ltp, and a total length of the pressing element 140 disposed in one of the second protruding ear structures 121 is Lto, the following condition can be satisfied:

$$\frac{1}{3} Lto \leq Ltp \leq \frac{2}{3} Lto .$$

Therefore, the connecting strength between the pressing element 140 and the handle 120 can be adjusted during the pressing process.

Furthermore, the toothed outer surface 142 of the pressing element 140 is directly contacted with the smooth inner surface 122 of one of the second protruding ear structures 121, so that the connecting strength between the pressing element 140 and the second protruding ear structure 121 can be enhanced during adjusting the angle between the driving head 110 and the handle 120. Therefore, the loose during adjusting the angle can be avoided.

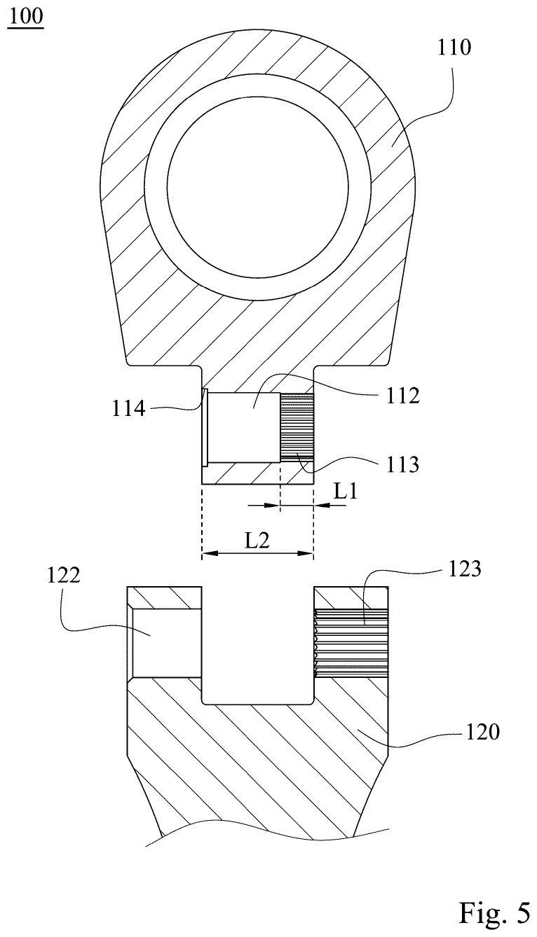

FIG. 5 is a partial cross-sectional view of the swing wrench 100 according to the example in FIG. 1. In FIG. 5, when a length of the toothed portion 113 is L1, and a total length of the smooth portion 112 and the toothed portion 113 is L2, the following condition is satisfied:

$$L 1 < \frac{1}{2} L 2.$$

Therefore, the connecting strength between the positioning element 130 and the driving head 110 can be adjusted. That is, the engagement range between the toothed end 131 of the positioning element 130 and the toothed portion 113 of the first protruding ear structure 111 can be adjusted.

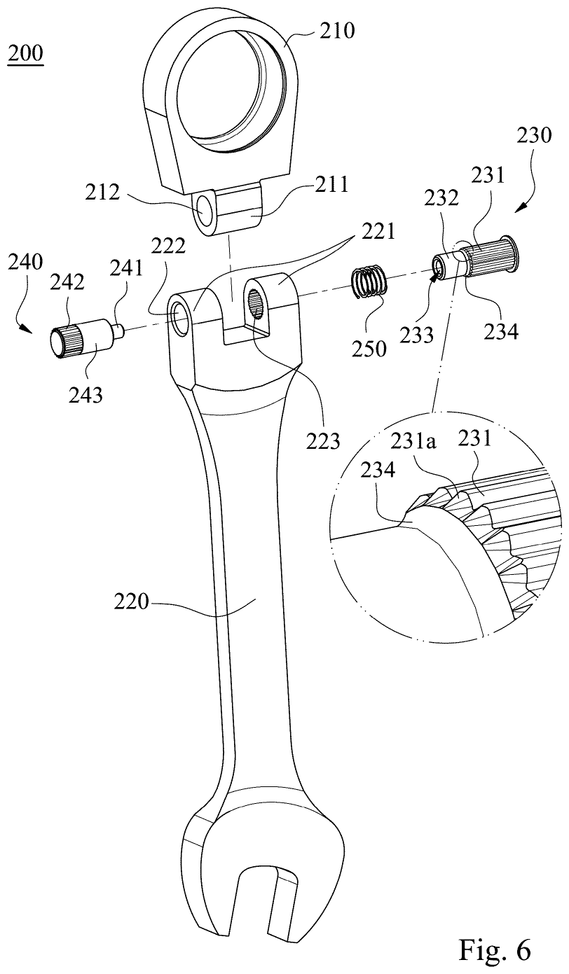

FIG. 6 is an exploded view of a swing wrench 200 according to another example of the present disclosure. In FIG. 6, the swing wrench 200 includes a driving head 210, a handle 220, a positioning element 230 and a pressing element 240, wherein the driving head 210 has a first protruding ear structure 211, the handle 220 has two second protruding ear structures 221, the first protruding ear structure 211 is disposed between the second protruding ear structures 221, the positioning element 230 is engaged with the pressing element 240, and the pressing element 240 and the positioning element 230 are disposed through the first protruding ear structure 211 and the second protruding ear structures 221. In detail, an end of the handle 220 can be an open end, but the present disclosure is not limited thereto.

An inner surface of the first protruding ear structure 211 has a smooth portion 212 and a toothed portion (its reference numeral is omitted), and the second protruding ear structures 221 can include a smooth inner surface 222 and a toothed inner surface 223, respectively, wherein the smooth inner surface 222 is corresponding to the smooth portion 212, and the toothed inner surface 223 is corresponding to the toothed portion 213.

Moreover, the positioning element 230 can have a toothed end 231 and a smooth end 232, wherein the toothed end 231 is engaged with the toothed inner surface 223 of the second protruding ear structure 221.

The pressing element 240 can have a first engaging end 241, a toothed outer surface 242 and a smooth outer surface 243, and the positioning element 230 can have a second engaging end 233, wherein the first engaging end 241 and the second engaging end 233 are engaged with each other, the first engaging end 241 can be a protruding structure, and a surface of the protruding structure is smooth. That is, the first engaging end 241 can be embedded in the second engaging end 233.

The swing wrench 200 can further include an elastic element 250, wherein the elastic element 250 is disposed on the smooth end 232 of the positioning element 230.

In FIG. 6, the toothed end 231 of the positioning element 230 has a corresponding toothed structure 231a, wherein the corresponding toothed structure 231a is disposed on an end of the toothed end 231, which is connected to the smooth end 232.

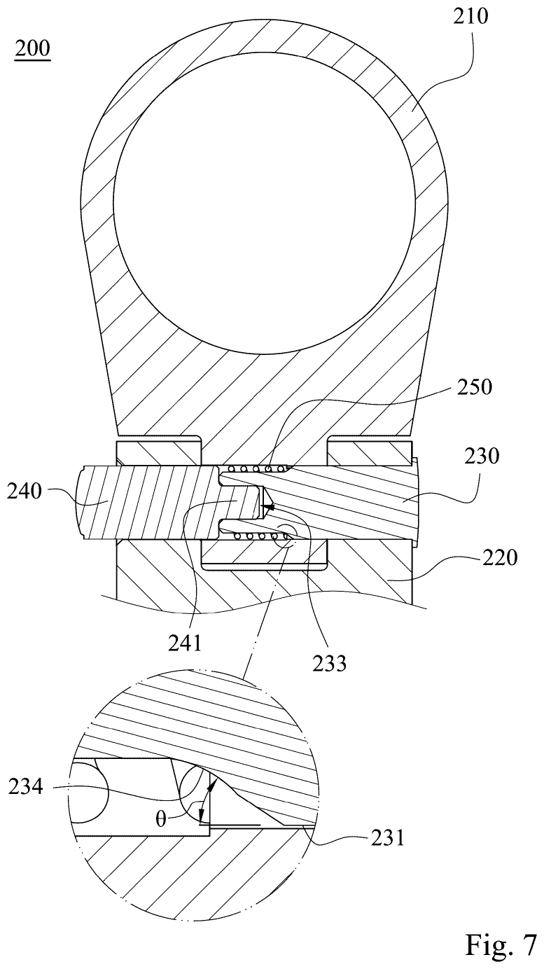

FIG. 7 is a cross-sectional view of the swing wrench 200 according to the example in FIG. 6, wherein FIG. 7 is the schematic view of the status of the swing wrench 200 without pressing the pressing element 240. In FIGS. 6 and 7, an end of the positioning element 230 has a tapered structure 234, wherein the tapered structure 234 is disposed between the toothed end 231 and the smooth end 232. When an angle between the tapered structure 234 and the toothed end 231 is θ, the following condition can be satisfied: 30 degrees≤θ≤60 degrees. Therefore, the structural strength of the positioning element 230 can be strengthened via the tapered structure 234. In particular, the tapered structure 234 can be a rounded corner structure, but the present disclosure is not limited thereto. Therefore, the structural strength can be further enhanced via the rounded corner structure, and the crack can be avoided.

Further, all of other structures and dispositions according to the example according to FIG. 6 are the same as the structures and the dispositions according to the example according to FIG. 1, and will not be described again herein.

In summary, via the cooperation among the first protruding ear structure, the second protruding ear structures, the pressing element and the positioning element of the swing wrench, the angle of the swing wrench can be flexibly adjusted before using the swing wrench, and the engagement strength can be enhanced after fixing the swing angle between the driving head and the handle. Therefore, the operating stability during the operating process can be strengthened. Further, the connecting strength between the positioning element and the driving head can be flexibly adjusted by the length relationship between the length of the toothed portion and the total length of the smooth portion and the toothed portion, so that the operation flexibility can be strengthened.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. A swing wrench, comprising:
a driving head having a first protruding ear structure, wherein an inner surface of the first protruding ear structure has a smooth portion and a toothed portion;
a handle having two second protruding ear structures, wherein the first protruding ear structure is disposed between the two second protruding ear structures;
a pressing element; and
a positioning element engaged with the pressing element, and the pressing element and the positioning element disposed through the first protruding ear structure and the two second protruding ear structures;
wherein a length of the toothed portion is L1, a total length of the smooth portion and the toothed portion is L2, and the following condition is satisfied:
$$L 1 < \frac{1}{2} L 2.$$

2. The swing wrench of claim 1, wherein the two second protruding ear structures have a smooth inner surface and a toothed inner surface, respectively, the smooth inner surface is corresponding to the smooth portion, and the toothed inner surface is corresponding to the toothed portion.

3. The swing wrench of claim 2, wherein the positioning element has a toothed end engaged with the toothed inner surface.

4. The swing wrench of claim 1, wherein the pressing element has a first engaging end, the positioning element has a second engaging end, and the first engaging end and the second engaging end are engaged with each other.

5. The swing wrench of claim 4, wherein the first engaging end is a protruding structure, and a surface of the protruding structure is smooth.

6. The swing wrench of claim 4, wherein the first engaging end is a protruding structure, and a surface of the protruding structure is threaded.

7. The swing wrench of claim 1, further comprising:
an elastic element disposed on a smooth end of the positioning element.

8. The swing wrench of claim 7, wherein the elastic element is a spring.

9. The swing wrench of claim 1, wherein the pressing element has a toothed outer surface and a smooth outer surface, a length of the toothed outer surface is Ltp, a total length of the pressing element disposed in one of the two second protruding ear structures is Lto, and the following condition is satisfied:
$$\frac{1}{3} Lto \leq Ltp \leq \frac{2}{3} Lto .$$

10. The swing wrench of claim 9, wherein the toothed outer surface of the pressing element is directly contacted with a smooth inner surface of one of the two second protruding ear structures.

11. The swing wrench of claim 1, wherein an end of the positioning element has a tapered structure, and the tapered structure is disposed between a toothed end and a smooth end of the positioning element.

12. The swing wrench of claim 11, wherein an angle between the tapered structure and the toothed end is θ, and the following condition is satisfied:
30 degrees≤θ≤60 degrees.

13. The swing wrench of claim 11, wherein the tapered structure is a rounded corner structure.

14. The swing wrench of claim 1, wherein a toothed end of the positioning element has a corresponding toothed structure disposed on an end of the toothed end, which is connected to a smooth end of the positioning element.

15. The swing wrench of claim 1, wherein the smooth portion has a threaded portion, and the threaded portion is located on an end of the smooth portion.
